(19) United States
(12) Patent Application Publication
(10) Pub. No.: US 2026/0111300 A1
(43) Pub. Date: Apr. 23, 2026

(54) ERROR MANAGEMENT FOR MEMORY APPARATUSES

(71) Applicant: Micron Technology, Inc., Boise, ID (US)

(72) Inventors: Pranjal Chauhan, San Jose, CA (US); Jayaprakash Naradasi, Bengaluru (IN); Tal Sharifie, Lehavim (IL); Yoav Weinberg, North York (CA); Andrew Chong, San Jose, CA (US); Melissa I. Uribe, El Dorado Hills, CA (US)

(21) Appl. No.: 19/356,610

(22) Filed: Oct. 13, 2025

Related U.S. Application Data
(60) Provisional application No. 63/709,747, filed on Oct. 21, 2024.

(51) Int. Cl. G06F 11/07

(52) U.S. Cl. CPC G06F 11/0772; G06F 11/0757; G06F 11/0784

(57) ABSTRACT

Error management for memory apparatuses is described herein. While error indications are primarily managed by a controller and alerted through the host interface, the controller can have a hardware component to independently manage some error indications to which it may be particularly susceptible, alerting through a timeout signal. This allows those error indications to be managed despite the controller's failure due to various errors.

### PRIORITY INFORMATION

This Application claims the benefits of U.S. Provisional Application Number 63/709,747, filed on Oct. 21, 2024, the contents of which are incorporated herein by reference.

### TECHNICAL FIELD

Embodiments of the disclosure relate generally to memory systems and sub-systems, and more specifically, relate to error management for memory apparatuses.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

Vehicles are becoming more dependent upon memory sub-systems to provide storage for components that were previously mechanical, independent, or non-existent. A vehicle can include a computing system, which can be a host for a memory sub-system. The computing system can run applications that provide component functionality. The vehicle may be driver operated, driver-less (autonomous), and/or partially autonomous. The memory device can be used heavily by the computing system in a vehicle.

### BRIEF DESCRIPTION OF THE DRAWINGS

The present disclosure will be understood more fully from the detailed description given below and from the accompanying drawings of various embodiments of the disclosure.

FIG. 1 illustrates an example of a computing system that includes a memory sub-system operating in accordance with some embodiments of the present disclosure.

FIG. 2 illustrates an example of an error management component that manages errors in association with operating a computing system in accordance with some embodiments of the present disclosure.

FIG. 3 illustrates an example of a computing system that includes a memory sub-system controller having an error management component operating in accordance with some embodiments of the present disclosure.

FIG. 4 is a flow diagram of an example method for managing errors associated with operating a computing system in accordance with some embodiments of the present disclosure.

FIG. 5 illustrates an example of a system including a computing system in a vehicle in accordance with some embodiments of the present disclosure.

### DETAILED DESCRIPTION

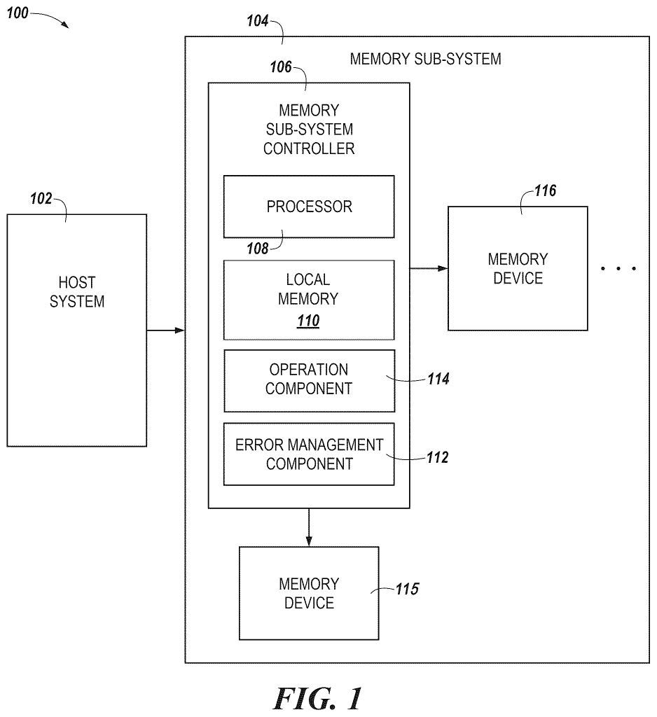

Aspects of the present disclosure are directed to error management for memory apparatuses, such as those within an automotive setting (e.g., autonomous vehicles). A memory sub-system can be a storage system, storage device, a memory module, or a combination of such. An example of a memory sub-system is a storage system such as a solid-state drive (SSD), Universal Flash Storage (UFS) drive, etc. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system. As an example, a vehicle can include a memory sub-system, such as an SSD, UFS, etc. The memory sub-system can be used for data storage by various components of the vehicle, such as applications that are run by a host system of the vehicle.

Autonomous apparatuses (autonomous vehicles, drones, vacuum cleaners, industrial robots, medical robots, etc.) can rely on various inputs to make decisions and perform specific tasks autonomously. These inputs can be obtained using various sources, such as various sensors, data networks, user inputs, preloaded data, external inputs, etc. These inputs collectively enable autonomous devices to analyze their environment, make decisions, and operate desirably with reduced human intervention. Due to the nature of fields where autonomous devices are used, it can be crucial that certain types of inputs are accurate and secure. For example, in situations where autonomous decisions are related to safety, faulty or incorrect inputs (e.g., data) can lead to undesirable outcomes, which could potentially endanger individuals. Memory devices may include components (e.g., CPU, firmware, etc.) that detect and report errors to hosts to alert them. However, the components themselves may often be susceptible to malfunctioning due to errors, which may interrupt the host's ability to function as a decision-making entity.

Aspects of the present disclosure address the above and other issues by providing a means to independently manage the errors to which the memory devices (e.g., components primarily handling errors) may be particularly susceptible. For example, various embodiments of the present disclosure provide a hardware component (e.g., circuitry) that can independently handle errors and terminate (alternatively referred to as “drop”) communication with the host when such errors are detected. This ensures that the memory devices'ability to manage errors is not interrupted by the mentioned errors, preventing the host from receiving potentially erroneous data and, thereby, preventing the host from making decisions based on unreliable information.

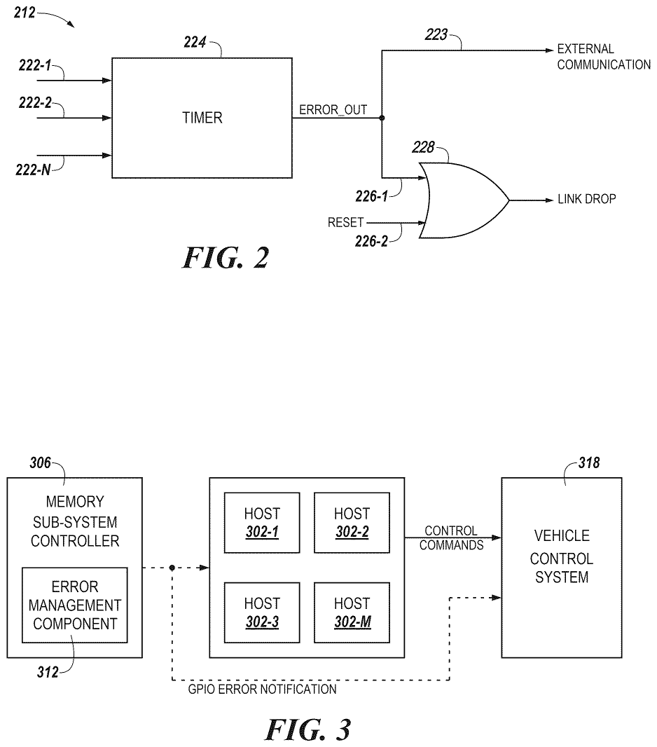

The figures herein follow a numbering convention in which the first digit or digits correspond to the drawing figure number and the remaining digits identify an element or component in the drawing. Similar elements or components between different figures may be identified by the use of similar digits. For example, 112 may reference element “12” in FIG. 1, and a similar element may be referenced as 212 in FIG. 2. Analogous elements within a Figure may be referenced with a hyphen and extra numeral or letter. Such analogous elements may be generally referenced without the hyphen and extra numeral or letter. For example, elements 222-1, 222-2, . . . , 222-N in FIG. 2 may be collectively referenced as 222. As used herein, the designator “N”, “M”, or “X”, particularly with respect to reference numerals in the drawings, indicates that a number of the particular feature so designated can be included. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

FIG. 1 illustrates an example computing system 100 that includes a memory sub-system 104 (alternatively referred to as memory device 104) operating in accordance with some embodiments of the present disclosure. The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 includes a host system 102 that is coupled to one or more memory sub-systems 104. The host system 102 can be a computing system included in a vehicle, and the computing system can run applications that provide component functionality for the vehicle, for example. In some embodiments, the host system 102 is coupled to different types of memory sub-systems 104. FIG. 1 illustrates an example of a host system 102 coupled to one memory sub-system 104. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 102 includes or is coupled to processing resources, memory resources, and network resources. As used herein, “resources” are physical or virtual components that have a finite availability within a computing system 100. For example, the processing resources include a processing device, the memory resources include memory sub-system 104 for secondary storage and main memory devices (not specifically illustrated) for primary storage, and the network resources include as network interface (not specifically illustrated). The processing device can be one or more processor chipsets, which can execute a software stack. The processing device can include one or more cores, one or more caches, a memory controller (e.g., NVDIMM controller), and a storage protocol controller (e.g., PCIe controller, SATA controller, etc.). The host system 102 uses the memory sub-system 104, for example, to write data to the memory sub-system 104 and read data from the memory sub-system 104.

The host system 102 can run one or more applications. For instance, the applications can run on an operating system (not specifically illustrated) executed by the host system 102. An operating system is system software that manages computer hardware, software resources, and provides common services for the applications. An application is a collection of instructions that can be executed to perform a specific task. By way of example, the application can be a black box application for a vehicle, however embodiments are not so limited.

The host system 102 can be coupled to the memory sub-system 104 via a physical host interface. Examples of a physical host interface include, but are not limited to, a serial advanced technology attachment (SATA) interface, a PCIe interface, universal serial bus (USB) interface, Fibre Channel, Serial Attached SCSI (SAS), Small Computer System Interface (SCSI), a double data rate (DDR) memory bus, a dual in-line memory module (DIMM) interface (e.g., DIMM socket interface that supports Double Data Rate (DDR)), Open not-and (NAND) Flash Interface (ONFI), Double Data Rate (DDR), Low Power Double Data Rate (LPDDR), or any other interface. The physical host interface can be used to transmit data between the host system 102 and the memory sub-system 104. The host system 102 can further utilize an NVM Express (NVMe) interface to access the non-volatile memory devices 116 when the memory sub-system 104 is coupled with the host system 102 by the PCIe interface. The physical host interface can provide an interface for passing control, address, data, and other signals between the memory sub-system 104 and the host system 102. FIG. 1 illustrates a memory sub-system 104 as an example. In general, the host system 102 can access multiple memory sub-systems via a same communication connection, multiple separate communication connections, and/or a combination of communication connections.

The host system 102 can control and/or send requests (e.g., commands) to the memory sub-system 104, for example, to store data in the memory sub-system 104 or to read data from the memory sub-system 104. For example, the host system 102 can use the memory sub-system 104 to provide storage for a black box application. The data to be written or read, as specified by a host request, is referred to as “host data.” A host request can include logical address information. The logical address information can be a logical block address (LBA), which may include or be accompanied by a partition number. The logical address information is the location the host system associates with the host data. The logical address information can be part of metadata for the host data. The LBA may also correspond (e.g., dynamically map) to a physical address, such as a physical block address (PBA), that indicates the physical location where the host data is stored in memory.

The memory sub-system 104 can include media, such as one or more volatile memory devices 115, one or more non-volatile memory devices 116, or a combination thereof. The volatile memory devices 115 can be, but are not limited to, random access memory (RAM), such as dynamic random access memory (DRAM), synchronous dynamic random access memory (SDRAM), and resistive DRAM (RDRAM).

A memory sub-system 104 can be a storage device, a memory module, or a hybrid of a storage device and memory module. Examples of a storage device include an SSD, a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

An example of non-volatile memory devices 116 include NAND type flash memory. NAND type flash memory includes, for example, two-dimensional NAND (2D NAND) and three-dimensional NAND (3D NAND). The non-volatile memory devices 116 can be other types of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, electrically erasable programmable read-only memory (EEPROM), and three-dimensional cross-point memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased.

The memory sub-system controller 106 (or controller 106 for simplicity) can communicate with the memory device 115, 116 to perform operations such as reading data, writing data, erasing data, and other such operations at the memory devices 115, 116. The memory sub-system controller 106 can include hardware such as one or more integrated circuits and/or discrete components, or a combination thereof. The hardware can include a digital circuitry with dedicated (i.e., hard-coded) logic to perform the operations described herein. The memory sub-system controller 106 can be a microcontroller, special purpose logic circuitry (e.g., a field programmable gate array (FPGA), an application specific integrated circuit (ASIC), etc.), or other suitable circuitry.

The memory sub-system controller 106 can include a processing device 108 (e.g., a processor, which can be a central processing unit (CPU)) configured to execute instructions stored in local memory 110. Local memory 110 can be, for instance, static random access memory (SRAM). In the illustrated example, the local memory 110 of the memory sub-system controller 106 is an embedded memory configured to store instructions for performing various processes, operations, logic flows, and routines that control operation of the memory sub-system 104, including handling communications between the memory sub-system 104 and the host system 102. For example, local memory 110 can store instructions that can be executed by the processor 108 and/or the operation component 114, as will be further described herein. As used herein, the “processor” can be alternatively referred to as “processing resource”.

In some embodiments, the local memory 110 can include memory registers storing memory pointers, fetched data, etc. The local memory 110 can also include ROM for storing micro-code, for example. While the example memory sub-system 104 in FIG. 1 has been illustrated as including the memory sub-system controller 106, in another embodiment of the present disclosure, a memory sub-system 104 does not include a memory sub-system controller 106, and can instead rely upon external control (e.g., provided by an external host, or by a processor or controller separate from the memory sub-system 104). In some embodiments, the memory sub-system 104 can be a managed NAND (MNAND) device in which an external controller (e.g., controller 106) is packaged together with one or more NAND die (e.g., the non-volatile memory device 116).

In general, the memory sub-system controller 106 can receive information or operations from the host system 102 and can convert the information or operations into instructions or appropriate information to achieve the desired access to the non-volatile memory devices 116 and/or the volatile memory devices 115. The memory sub-system controller 106 can be responsible for other operations such as wear leveling operations, error detection and/or correction operations, encryption operations, caching operations, and address translations between a logical address (e.g., logical block address) and a physical address (e.g., physical block address) associated with the non-volatile memory devices 116. The memory sub-system controller 106 can further include host interface circuitry to communicate with the host system 102 via the physical host interface. The host interface circuitry can convert a query received from the host system 102 into a command to access the non-volatile memory devices 116 and/or the volatile memory devices 115 as well as convert responses associated with the non-volatile memory devices 116 and/or the volatile memory devices 115 into information for the host system 102.

As shown in FIG. 1, the memory sub-system 104 can include error management component 112 and an operation component 114. Although not shown in FIG. 1 so as to not obfuscate the drawings, the error management component 112 can include various circuitry to facilitate aspects of the disclosure described herein. In some embodiments, the error management component 112 and/or the operation component 114 can include firmware, special purpose circuitry in the form of an ASIC, FPGA, state machine, hardware processing device, and/or other logic circuitry that can allow the error management component 112 and/or the operation component 114 to orchestrate and/or perform operations described herein.

The operation component 114, which can be firmware or hardware, or any combination thereof, can manage and/or control operations of the computing system 100 (e.g., such as an autonomous device). In some embodiments, the operation component 114 can be part of (e.g., integrated part of) the processor 108 (e.g., CPU).

The operation component 114 allows the host 102 to operate autonomously or in an autonomous mode (alternatively referred to as a “mission mode”) to analyze the environment based on various inputs, make decisions, and operate desirably with reduced human intervention. Additionally, the operation component 114 ensure that the operations of the computing system 100 meet safety standards, for example, as defined by the Safety Standard ISO 26262. These functionalities provided by the operation component 114 to meet the requirements for the autonomous mode and/or the safety standard can include detecting errors, correcting the errors, or notifying the host 102 of the errors, among others.

The operation component 114 can be a “primary” error managing entity that handles or manages errors of the computing system 100 (or at least the memory sub-system 104). However, some errors that the operation component 114 (and/or the processor 108) can be particularly susceptible (so that the error managing/notifying capabilities of the operation component 114 can itself become malfunctioning due to the errors) can rather be managed independently at the error management component 112 (which can be a “secondary” error managing entity).

Accordingly, errors of various components of the computing system 100 that may adversely affect the capabilities of the operation component 114 can instead be (e.g., configured to be) managed at the error management component 112, rather than the operation component 114. For example, the controller 106 can route error indications of those types of errors to the error management component 112 instead of the operation component 114. The error management component 112 may prevent the received error indications or erroneous/incorrect data associated with these indications from being further provided (e.g., reported) to the host 102. This provides a secondary and independent means to handle errors that would have otherwise interrupted the functionalities of the memory sub-system 104 (absent the error management component 112), which would have further caused the memory sub-system 104 to allow reporting of potentially incorrect or faulty data to the host 102. Further details of this process are illustrated in association with FIGS. 2-4.

FIG. 2 illustrates an example of an error management component 212 that manages errors (e.g., error messages) in association with operating a computing system in accordance with some embodiments of the present disclosure. The error management component 212 can be analogous to the error management component 112 illustrated in FIG. 1.

As illustrated in FIG. 2, the error management component 212 can include timer circuitry 224 (simply referred to as “timer”), which can be referred to as timer circuitry 224. In some embodiments, the timer circuitry 224 can be a watch dog timer circuitry (WDT), although embodiments are not so limited. As used herein, the term WDT refers to specialized timer circuitry configured to reset or enable resetting of the system (e.g., memory sub-system 100) if the timeout period (e.g., timeout interval) expires within being reset.

The timer circuitry 224 can receive error indications 222-1, 222-2, and 222-N (collectively referred to as error indications 222, or simply indications 222) from various “sources”. The timer circuitry 224 can include a memory (e.g., RAM, Flash Memory, EEPROM, non-volatile RAM (NVRAM), SD Card,) that can store (e.g., at least temporarily) error indications 222. The error indications 222 (alternatively referred to as “error messages”, “error notifications”, or the like) can be indications of errors of the respective sources, such as errors in data received from and/or malfunctions of the respective sources.

Various operational issues, such as errors etc. can be reported in the form of error indications 222. The operational issues can include, but are not limited to, errors such as data corruption, memory wear-out, performance degradation, hardware failures, power loss, temperature-related issues (e.g., malfunctions and/or incorrect/faulty reading of temperature sensors), clock failures, voltage failures (e.g., incorrect of faulty voltage level of one or more voltage regulators, such as a low dropout regulator (LDO), alternating current (AC)/direct current (DC) converter, DC/DC buck converter, switching capacitance, etc.) of the computing system (e.g., the computing system 100 illustrated in FIG. 1) and/or the memory sub-system (e.g., the memory sub-system 104), CPU reset failure (e.g., during the initialization process of the memory sub-system, such as the memory sub-system 104 illustrated in FIG. 1), bad memory blocks, firmware bugs, connection problems, security breaches, etc.

The error indications (e.g., the indications 222) associated with these operational issues can be generated at respective sources, detectors, etc., such as temperature sensors configured to monitor the temperature of components of the computing system 100, voltage sensors configured to monitor output voltage levels of voltage regulators, clock monitors configured to monitor the integrity of the clock signals, current sensors configured to monitor the current flowing through various components or circuits of the computing system 100, error correction code (ECC) components that are configured to detect errors in data using CRC, parity data, etc. In some embodiments, the error indications 222 can be managed as “asynchronous events” independent of timing requirements for data signals, clock signals, etc., which allows signals indicative of the error indications 222 to be used without requiring the timing synchronization mechanisms.

Error indications associated with some of those operational issues can be configured (e.g., preconfigured during the initialization stage, such as a booting stage, of the memory sub-system 104) to be routed to the timer circuitry 224 instead of a different entity, such as the operation component 114 illustrated in FIG. 1. For example, these indications can be associated with incorrect or faulty data that would interrupt the operation of the operation component 114.

More particularly, the error indications 222 that can be directly routed to the timer circuitry 224 can include error indications of clock failures (e.g., sent from clock signal generators and/or detectors), error indications from temperature sensors, error indications of voltage failures (as detected by a detector configured to monitor voltage levels of voltage regulators), error indications of CPU reset failures, although embodiments are not so limited. As further illustrated herein, these error indications 222, when received by the timer circuitry 224, can often lead to the trigger of a signal drop (alternatively referred to as “link drop”) to prevent the faulty and/or incorrect data (that triggered error indications 222) from being transferred to the host 102.

As illustrated in FIG. 2, the timer circuitry 224 can output an “ERROR_OUT” signal (alternatively referred to as “timeout signal”) responsive to the “timeout period” having been expired. The “timeout period” of the timer circuitry 224 can be allowed to expire absent a reset signal provided from the controller 106 (e.g., the operation component 114 and/or the processor 108 illustrated in FIG. 1). For example, during operation of the computing system 100 and/or memory sub-system 104, the controller 106 (e.g., the operation component 114) can (e.g., periodically) reset the timer circuitry 224 before the timeout period expires. This can continue unless the malfunction of the memory sub-system 104 (and/or the operation component 114) prevents the reset signal from being provided to the timer circuitry 224. Although embodiments are not so limited, the timeout value can be configured by the operation component 114 during an initialization stage (e.g., the botting stage) of, for example, the computing system 100 and/or memory sub-system 104.

The “ERROR_OUT” signal can be provided to the logic gate 228. Although embodiments are not so limited, the logic gate 228 can be an OR gate. The logic gate 228 receives two input signals: one input signal being an “ERROR_OUT” signal from the timer circuitry 224 and another input signal being a “RESET” signal as shown in FIG. 2.

An output signal (alternatively referred to as “trigger signal”) from the logic gate 228 can trigger a signal drop depending on its value (e.g., logical value of the signal). For example, given that the input signal 226-2 has been drive “HIGH” regardless of whether the timeout period (e.g., of the timer circuitry 224) has been expired or not, the “ERROR_OUT” signal 226-1 can be asserted when the “timeout period” of the timer circuitry 224 has been expired. This further causes an output signal from the logic gate 228 to be asserted, which can trigger a signal drop.

As used herein, the term “signal drop” refers to a loss (e.g., intentional loss) of communication between two entities, such as between the host 102 and the memory sub-system 104. For example, the “signal drop” can be achieved by resetting the memory sub-system 104, or putting the memory sub-system 104 into a reduced power state (e.g., inactive, power sleep, or power-off state), among others. The operation of the error management component 212, as described in association with FIG. 2, primarily involves operating simplified hardware components (e.g., the timer circuitry 224, the logic gate 228, etc.) that may be less susceptible to errors. These error indications may be routed to the error management component 212. In contrast, the operation component 114, which relies on more complex firmware and CPU-based operations, is more prone to such errors. Therefore, independently managing these errors at the error management component 212 of the simplified hardware components may prevent situations where the failure or malfunction of the firmware or the CPU leads to the controller 106 not filtering the errors before they are provided to the host 102.

The signal drop triggered by timer circuitry 224 can prevent the host 102 from engaging in decision-making processes based on faulty or incorrect data that would have been provided from the controller 106 (e.g., due to the malfunctioning of the operation component 114). This helps avoid safety risks, especially when the host 102 relies on real-time data obtained from the memory sub-system 104 for its decision-making processes. By ensuring that only accurate data is used, particularly within short time frames, overall safety and reliability of the computing system 100 can be enhanced.

The timer circuitry 224 can further provide information associated with (e.g., a status of) the error indication (e.g., one of the indications 222 received at the timer circuitry 224) via a communication channel 223 (e.g., sideband channel), which can include one or more pins, such as General-Purpose Input/Output (GPIO) pins. In some embodiments, the communication channel can be a secondary communication channel (e.g., a sideband channel) in addition to a primary communication channel. The communication channel as a sideband channel can operate in parallel with the primary communication channel, which improves response time to the host 102 and/or the vehicle control system (e.g., the vehicle control system 318 illustrated in FIG. 3).

The communication channel 223 can serve as a means to communicate further details/information of error indications 222 (that has been stored in the timer circuitry 224) external to the timer 224 (e.g., to the host), such as the source of the error (e.g., from a temperature sensor), the type of error detected, the severity of the error, the timestamp when the error occurred, etc. For example, the host 102 may detect the “signal drop” subsequent to detecting a lack of communication from the controller 106 for a particular period of time. In this event, the host 102 (e.g., automotive system applications) that has been monitoring the controller 106 can request or poll the details of indications 222 from the controller 106.

FIG. 3 illustrates an example of a computing system 300 that includes a memory sub-system controller 306 having an error management component 312 operating in accordance with some embodiments of the present disclosure. The computing system 300, the memory sub-system controller 306 (simply referred to as controller 306), the error management component 312, and hosts 302-1, ...., 302-M (collectively referred to as hosts 302) can be analogous to the computing system 100, the memory sub-system controller 106, the error management component 112, and host 102 illustrated in FIG. 1, respectively.

As illustrated in FIG. 3, the hosts 302 and the controller 306 can be further coupled to the vehicle control component 318. The vehicle control component 318 can manage physical control of one or more vehicles (based on requests, commands, etc. received from the hosts 302 or input data received from the controller 306), for example, when the vehicles are operated autonomously or partially autonomously. For example, the physical control of the vehicles that can be managed by the vehicle control component 318 can include switching the ignition or the start control that controls the start of the vehicle; turning the steering wheel or the steering or steering device that controls the steer of the vehicle; course or direction of the vehicle; increasing or decreasing the throttle or acceleration or the throttle control that controls the speed of the vehicle, thus changing the speed of the vehicle; applying or releasing the brakes; switching on/off direction indicators; controlling lights on the vehicle (e.g., by turning on/off the headlamps, parking brakes, fog lights etc.); activating warning signals (e.g., sounding a horn; hazard lights); locking or unlocking the doors; activating the windscreen wipers; parking sensors or controls; and/or changing the gear of the vehicle, among others.

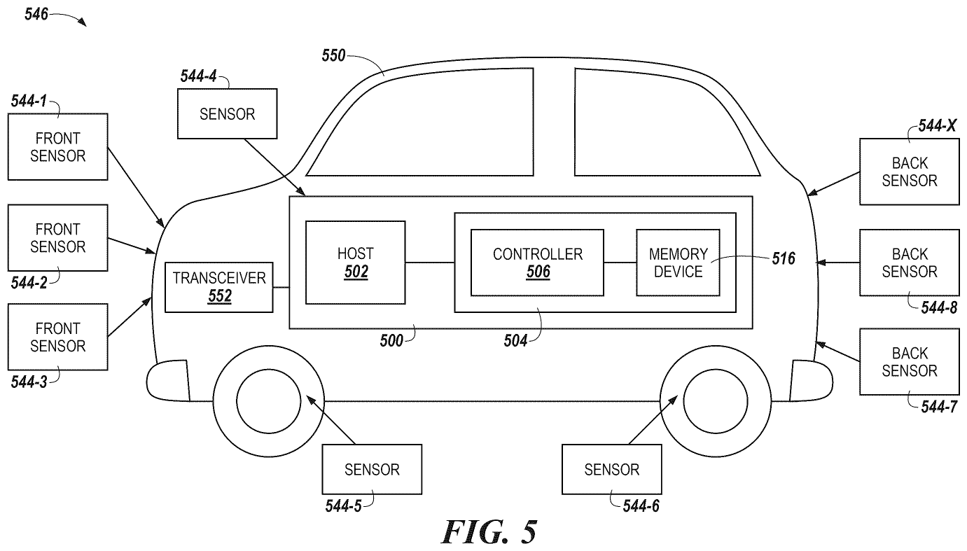

The hosts 302 can operate based on inputs provided from the memory sub-system (e.g., the memory sub-system 104 illustrated in FIG. 1) and/or various sensors (e.g., the sensors 544 illustrated in FIG. 5). The vehicle control system 318 can also operate to provide the functionalities described herein based on requests, commands, etc. provided from the host 302 and/or inputs provided from the memory sub-system 104 and/or various sensors 544. Information associated with errors (e.g., types of errors), sources of errors, and/or indications of such (e.g., indications 222 illustrated in FIG. 2) can be communicated from the controller 306 to at least one of the hosts 302 and/or the vehicle control system 318, for example, via one or more pins, such as GPIO pins.

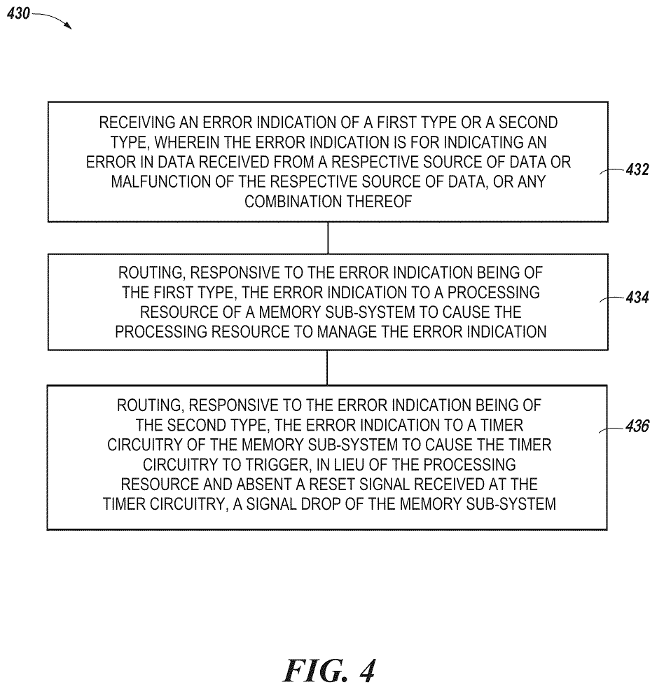

FIG. 4 is a flow diagram of an example method 430 for managing errors associated with operating a computing system (e.g., the computing system 100 illustrated in FIG. 1) in accordance with some embodiments of the present disclosure. The method can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by or using the memory sub-system controller 106 shown in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At 432, the method 430 can include receiving an error indication of a first type or a second type, wherein the error indication is for indicating an error in data received from a respective source of data or malfunction of the respective source of data, or any combination thereof. At 434, the method 430 can further include routing, responsive to the error indication being of the first type, the error indication to a processing resource (e.g., the processing resource 108 illustrated in FIG. 1) of a memory sub-system (e.g., the memory sub-system 104 illustrated in FIG. 1) to cause the processing resource to manage the error indication.

At 436, the method 430 can further include routing, responsive to the error indication being of the second type (e.g., the indications 222 illustrated in FIG. 2), the error indication to a timer circuitry (e.g., the timer 224 illustrated in FIG. 2) of the memory sub-system 104 to cause the timer circuitry 224 to trigger, in lieu of the processing resource 108 and absent a reset signal received at the timer circuitry 224, a signal drop of the memory sub-system 104. The signal drop of the memory sub-system 104 can prevent data associated with the error indication 222 from being transferred external to the memory sub-system 104. The signal drop of the memory sub-system 104 can include putting the memory sub-system 104 into a reduced power state, or resetting the memory sub-system, or any combination thereof.

In some embodiments, information associated with the indication 222 out responsive to receiving a request for the information can be transferred (e.g., out to the host, such as the host 102, 302, 502 illustrated in FIGS. 1, 3, and 5, respectively). The information can be information for a source of errors, a type of the errors associated with the indications 222, or any combination thereof. Further, the information can be transferred via a general-purpose input/output (GPIO) pin.

FIG. 5 illustrates an example of a system 546 including a computing system 500 in a vehicle in accordance with some embodiments of the present disclosure. The computing system 500 can include a memory sub-system 504, which is illustrated as including a controller 506 and non-volatile memory device 516 for simplicity but is analogous to the memory sub-system 104 illustrated in FIG. 1. The computing system 500, and thus the host 502, can be coupled to a number of sensors 544 either directly, as illustrated for the sensor 544-4 or via a transceiver 552 as illustrated for the sensors 544-1, 544-2, 544-3, 544-5, 544-6, 544-7, 544-8, ..., 544-X (collectively referred to as sensors 544). The transceiver 552 is able to receive data from the sensors 544 wirelessly, such as by radio frequency communication. In at least one embodiment, each of the sensors 544 can communicate with the computing system 500 wirelessly via the transceiver 552. In at least one embodiment, each of the sensors 544 is connected directly to the computing system 500 (e.g., via wires or optical cables).

The vehicle 550 can be a car (e.g., sedan, van, truck, etc.), a connected vehicle (e.g., a vehicle that has a computing capability to communicate with an external server), an autonomous vehicle (e.g., a vehicle with self-automation capabilities such as self-driving), a drone, a plane, a ship, and/or anything used for transporting people and/or goods. The sensors 544 are illustrated in FIG. 5 as including example attributes. For example, sensors 544-1, 544-2, and 544-3 are cameras collecting data from the front of the vehicle 550. Sensors 544-4, 544-5, and 544-6 are microphone sensors collecting data from the front, middle, and back of the vehicle 550. The sensors 544-7, 544-8, and 544-X are cameras collecting data from the back of the vehicle 550. As another example, the sensors 544-5, 544-6 are tire pressure sensors. As another example, the sensor 544-4 is a navigation sensor, such as a global positioning system (GPS) receiver. As another example, the sensor 544-6 is a speedometer. As another example, the sensor 544-4 represents a number of engine sensors such as a temperature sensor, a pressure sensor, a voltmeter, an ammeter, a tachometer, a fuel gauge, etc. As another example, the sensor 544-4 represents a camera. Video data can be received from any of the sensors 544 associated with the vehicle 550 comprising cameras. In at least one embodiment, the video data can be compressed by the host 502 before providing the video data to the memory sub-system 504.

The host 502 can execute instructions to provide an overall control system and/or operating system for the vehicle 550. The host 502 can be a controller designed to assist in automation endeavors of the vehicle 550. For example, the host 502 can be an advanced driver assistance system controller (ADAS). An ADAS can monitor data to prevent accidents and provide warning of potentially unsafe situations. For example, the ADAS can monitor sensors in the vehicle 550 and take control of vehicle 550 operations to avoid accident or injury (e.g., to avoid accidents in the case of an incapacitated user of a vehicle). The host 502 may need to act and make decisions quickly to avoid accidents. The memory sub-system 504 can store reference data in the non-volatile memory device 116 such that data from the sensors 544 can be compared to the reference data by the host 502 in order to make quick decisions.

The sensors 544 can be monitored respectively by one or more detectors (not illustrated in FIG. 5) that can indicate errors associated with the sensors (e.g., errors in data obtained at the sensors 544, malfunctions of the sensors 544, etc., among others). Although embodiments are not so limited, the detector can be embedded into and/or integrated part of the sensors 544. The detectors may generate error indications when the errors are detected and route the error indications to either host 502 or the controller 506. When the error indications are routed to the controller 506 (e.g., such as to the error management component 112, 312), the controller 506 can often prevent sensors 544 from providing their measured/sensed data to the host 502 and/or prevent the received error indication themselves from being provided (further routed) to the host 502. This can occur when the “timeout period” of the timer (e.g., the timer 224 illustrated in FIG. 2) has expired as described herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a machine-readable storage medium, such as, but not limited to, types of disks, semiconductor-based memory, magnetic or optical cards, or other types of media suitable for storing electronic instructions.

The present disclosure can be provided as a computer program product, or software, that can include a machine-readable medium having stored thereon instructions, which can be used to program a computer system (or other electronic devices) to perform a process according to the present disclosure. A machine-readable medium includes a mechanism for storing information in a form readable by a machine (e.g., a computer).

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. An apparatus, comprising:
a controller configured to manage a first type of error indications and a second type of error indications independently, wherein each error indication indicating an error in data received from a respective source of data or malfunction of the respective source of data, or any combination thereof;
wherein the controller comprises timer circuitry and is further configured to:
receive an error indication of the second type;
selectively route the error indication of the second type to the timer circuitry to cause the timer circuitry to trigger a signal drop from the apparatus absent a rest signal received at the timer circuitry within a particular period of time, wherein a timeout signal causes the controller to be in a reduced power state to prevent one or more errors associated with the error indication of the second type from being transferred external to the apparatus.

2. The apparatus of claim 1, wherein the controller further comprises a processing resource, wherein the controller is configured to:
receive an error indication of the first type; and
selectively route the error indication of the first type to the processing resource of the controller such that the error indication of the first type is managed by the processing resource.

3. The apparatus of claim 2, wherein the processing resource is further configured to periodically reset the timer circuitry of the controller to prevent a timeout period of the timer circuitry from being expired.

4. The apparatus of claim 2, wherein the processing resource is further configured to selectively alert a host of the error indication of the first type.

5. The apparatus of claim 1, wherein information associated with the error indication of the first type is accessed by a host via a communication channel including a general-purpose input/output (GPIO) pin.

6. The apparatus of claim 1, wherein the processing resource comprises a central processing unit (CPU), or firmware, or any combination thereof.

7. The apparatus of claim 1, wherein the error indication of the second type is for indicating:
a clock signal malfunction;
a temperature sensor malfunction;
a voltage regulator malfunction; or
a failure of a central processing unit (CPU) reset process during an initialization stage; or any combination thereof.

8. The apparatus of claim 1, wherein the signal drop from the apparatus further causes:
a reduced power state of the apparatus; or
reset of the apparatus; or any combination thereof.

9. A method, comprising:
receiving an error indication of a first type or a second type, wherein the error indication is for indicating an error in data received from a respective source of data or malfunction of the respective source of data, or any combination thereof;
routing, responsive to the error indication being of the first type, the error indication to a processing resource of a memory sub-system to cause the processing resource to manage the error indication; and
routing, responsive to the error indication being of the second type, the error indication to a timer circuitry of the memory sub-system to cause the timer circuitry to trigger, in lieu of the processing resource and absent a reset signal received at the timer circuitry, a signal drop of the memory sub-system, wherein the signal drop of the memory sub-system prevents data associated with the error indication from being transferred external to the memory sub-system.

10. The method of claim 9, further comprising, responsive to the timeout signal and to prevent data associated with the error indication from being transferred external to the memory sub-system:
putting the memory sub-system into a reduced power state; or
resetting the memory sub-system.

11. The method of claim 9, further comprising:
transferring information associated with the error indication out of the timer responsive to receiving a request for the information; and
wherein the information comprises information associated with a source of errors, a type of the errors, or any combination thereof.

12. The method of claim 11, further comprising transferring the information out via a communication channel including a general-purpose input/output (GPIO) pin.

13. An apparatus, comprising:
a logic gate; and
a timer circuitry coupled to the logic gate, the timer circuitry configured to:
receive a signal indicative of an error indication of a particular type of a plurality of types, wherein the error indication of each type of the plurality of types is for an error in data from a respective source of data, or a malfunction in the respective source of data, or any combination thereof; and
provide a timeout signal to the logic gate absent a reset signal received at the timer circuitry within a particular period of time, wherein the reset signal resets the timer circuitry to prevent a timeout period of a timeout period of the timer circuitry from being expired; and
the logic gate configured to:
in response to receipt of the timeout signal from the timer circuitry, output a trigger signal to trigger a signal drop of the apparatus to prevent data associated with the error indication from being transferred out of the apparatus.

14. The apparatus of claim 13, wherein the logic gate is configured to:
receive input signals having:
a first input signal corresponding to the timeout signal; and
a second input signal; and
output the trigger signal when each one of the input signals is driven to correspond to a first logical value.

15. The apparatus of claim 14, wherein the logic gate is an OR logic gate.

16. The apparatus of claim 13, wherein the timer circuitry is configured to prevent the timeout signal being provided to the logic gate in response to receipt of the reset signal within the particular period of time.

17. The apparatus of claim 13, wherein the apparatus is an autonomous vehicle.

18. The apparatus of claim 17, wherein error indications of the plurality of types respectively correspond to errors in data obtained from or malfunctions of respective sensors of the autonomous vehicle.

19. The apparatus of claim 13, wherein error indications of the particular type are configured to be routed to the timer circuitry during an initialization stage of the apparatus.

20. The apparatus of claim 13, wherein the timer circuitry is configured to:
store information associated with the error indication; and
transfer the information associated with the error indication via a sideband channel in response to receipt of a request for the information.
